(19) United States
(12) Patent Application Publication
(10) Pub. No.: US 2011/0010559 A1
(43) Pub. Date: Jan. 13, 2011

(54) METHOD FOR ENCRYPTING DIGITAL FILE, METHOD FOR DECRYPTING DIGITAL FILE, APPARATUS FOR PROCESSING DIGITAL FILE AND APPARATUS FOR CONVERTING ENCRYPTION FORMAT

(75) Inventors: Jong Young Kim, Seoul (KR); Sung Won Cho, Incheon (KR); Dong Uk Lee, Seoul (KR); Jong Uk Choi, Seoul (KR)

Correspondence Address: OCCHIUTI ROHLICEK & TSAO, LLP, 10 FAWCETT STREET, CAMBRIDGE, MA, 02138, US

(73) Assignee: MARKANY INC., Seoul (KR)

(21) Appl. No.: 12/743,641

(22) PCT Filed: Nov. 13, 2008
(86) PCT No.: PCT/KR2008/006687

§ 371 Date: Sep. 29, 2010

(30) Foreign Application Priority Data
Nov. 22, 2007 (KR) 10-2007-0119945
Dec. 7, 2007 (KR) 10-2007-0126690

(51) Int. Cl. G06F 21/00; H04L 9/08; G06F 9/06

(52) U.S. Cl. 713/189; 380/283

(57) ABSTRACT

Disclosed herein are a digital file encryption method, a digital file decryption method, a digital file processing apparatus, and an encryption format conversion apparatus. The digital file encryption method includes encrypting a file using specific encryption information, storing the encrypted file in a file system, and storing the encryption information in a stream provided by the file system. Accordingly, since file lengths before and after encryption are identical to each other, an application needs not to consider a header length or perform offset correction when using an encrypted file.

### TECHNICAL FIELD

The present invention relates to a digital file encryption method, a digital file decryption method, a digital file processing apparatus, and an encryption format conversion apparatus, and more particularly, to a digital file encryption method and related technologies thereof, which store encryption information of an encrypted file in a stream provided by a file system when encrypting files.

### BACKGROUND ART

In general, digital information can be easily exposed to illegal copy and illegal use because it can be duplicated unlimitedly without loss of information. For a digital information service, digital information security technology must be supported which is capable of safely protecting digital information from illegal copy and use.

Digital rights management (DRM) is a comprehensive digital information security technology, which can prevent illegal copy and use of digital information and enables only users who have legitimate rights to use digital information. Such DRM puts emphasis on fundamentally preventing illegal copy and use of digital information. For example, in DRM, digital information is converted into encryption data using an encryption technology. Accordingly, although a specific user has acquired digital information accidentally, the user cannot use the corresponding digital information without experiencing a legal certification procedure.

A conventional data encryption method is described below. Conventionally, a raw-data file is encrypted using specific encryption information, and corresponding encryption information is inserted into a front or rear part of the encryption data as a header or a footer. However, in this case, since the entire size of the file is changed, portions to be processed when a subsequent application uses the encryption data file increase.

FIG. 1 is an exemplary view showing a conventional digital data encryption method.

As shown in FIG. 1, conventionally, a raw-data file (for example, A.txt) is encrypted, thus being converted into encryption data, and corresponding encryption information is inserted into the encryption data as a header 22 or a footer 24. Accordingly, the length of an encrypted file (for example, A_Enc.txt) becomes longer than that of the raw-data file as much as the length of the header 22 or the footer 24.

Accordingly, when using an encrypted file, an application must perform a specific process, for example, a correction process on the length and offset of the encrypted file in order to make a file input/output (I/O) with respect to the encrypted file identical to a file I/O with respect to raw-data. However, a problem arises because, when a correction process is performed on the length and offset of an encrypted file, stability is significantly lowered depending on applications.

For example, if a header is inserted into a front part of encryption data, operations to be processed increase because, when using an encrypted file, an application must take portions of an original file, which are pushed behind by the header, into consideration. In other words, when reading encryption data, an application must read a rear part of a header of the encryption data in consideration of the length of the header and, when newly writing data, write the data by pushing the encryption data behind that much.

However, when implementing this technology using an application program interface (API) hooking or filter driver technology, many number of cases occurs depending on operating systems and use applications, and actually, a possibility that malfunction may happen accordingly increases.

### DISCLOSURE OF INVENTION

### Technical Problem

Accordingly, the present invention has been made in view of the above problems, and it is an object of the present invention to provide a digital file encryption method, which stores encryption information of an encrypted file in a stream provided by a file system.

Further, it is another object of the present invention to provide a digital file decryption method, which is capable of decrypting an encrypted file created by the method of encrypting digital files.

Further, it is still another object of the present invention to provide a digital file processing apparatus, which is capable of storing encryption information in a stream when encrypting a file and decrypting an encrypted file using encryption information stored in a stream.

Further, it is further still another object of the present invention to provide an encryption format conversion apparatus, which is capable of converting an encryption format using a stream into an encryption format using an existing header, and vice versa.

### Technical Solution

To achieve the above objects, an aspect of the present invention provides a digital file encryption method. The method of encrypting digital files may include the steps of encrypting a file using specific encryption information and storing the encrypted file in a file system; and storing the encryption information in a stream provided by the file system. At this time, the encryption information may include a data encryption/decryption key, which was used to encrypt the file, and policy information about the file.

The step of storing the file in the file system may include the steps of converting the file to the encrypted file by encrypting the file using the data encryption/decryption key; and storing the encrypted file in the file system.

The step of storing the encryption information in the stream may include the steps of encrypting the encryption information using a specific encryption key; and storing the encrypted encryption information in the stream in association with the encrypted file. At this time, a name of the encryption information may include a name of the encrypted file, a specific identification symbol, and a unique name.

The digital file encryption method may further include the steps of acquiring a specific file input/output (I/O) to be processed by hooking and filtering file I/Os generated from an application; and analyzing the acquired file I/O in order to determine whether a corresponding file requires encryption.

Meanwhile, in order to achieve another object, another aspect of the present invention provides a digital file decryption method. The digital file decryption method may include the steps of, in order to decrypt an encrypted file stored in a file system, acquiring encryption information stored in a stream provided by the file system; and decrypting the encrypted file using data encryption/decryption key included in the encryption information.

The step of acquiring the encryption information may include the steps of acquiring encrypted encryption information stored in the stream; decrypting the encrypted encryption information using a specific decryption key; and acquiring the data encryption/decryption key from the decrypted encryption information.

The digital file decryption method may further the steps of acquiring a specific file I/O to be processed by hooking and filtering file I/Os generated from an application; and analyzing the acquired file I/O in order to determine whether a corresponding file requires decryption.

Meanwhile, in order to achieve still another object, still another aspect of the present invention provides a digital file processing apparatus. The digital file processing apparatus includes a file encryption module for encrypting a file, requiring encryption, using specific encryption information, storing the encrypted file in a file system, and storing the encryption information in a stream in association with the stored encrypted file; and a file decryption module for acquiring the encryption information of the encrypted file from the stream and decrypting the encrypted file using the acquired encryption information.

The file encryption module may convert the specific file into the encrypted file using a data encryption key, which is generated on its own or provided externally, and store the encryption information, including the data encryption key, in the stream. At least one of the file encryption module and the file decryption module may hook and filter file I/Os generated from an application.

The digital file processing apparatus may further include an encryption format conversion module for converting a first encryption format into a second encryption format. At this time, the first encryption format is an encryption format of a type in which encryption information of an encrypted file is stored in a stream, and the second encryption format is an encryption format of a type in which encryption information of an encrypted file is inserted into the encrypted file as a header or a footer of the encrypted file.

The encryption format conversion module may further include a function of converting the second encryption format into the first encryption format.

The digital file processing apparatus may further include a filter module for allowing only permitted applications to access the stream having the encryption information, and precluding non-permitted applications from accessing the stream having the encryption information.

Meanwhile, in order to achieve still another object, still another aspect of the present invention provides an encryption format conversion apparatus. The encryption format conversion apparatus may include a first module for converting a file, encrypted using a first encryption format, into a file having a second encryption format; and a second module for converting a file, encrypted using the second encryption format, into a file having the first encryption format. The first encryption format is an encryption format of a type in which encryption information of an encrypted file is stored in a stream, and the second encryption format is an encryption format of a type in which encryption information of an encrypted file is inserted into the encrypted file as a header or a footer of the encrypted file.

### ADVANTAGEOUS EFFECTS

As described above, according to the present invention, when encrypting a digital file, encryption information of an encrypted file is stored in a stream provided by a file system. Thus, additional information can be stored together with the encrypted file while not changing a file length even after the encryption. Accordingly, the present method is much stable than a conventional file encryption method in which the header length of a file must be considered after encryption. Further, an encrypted file stored in this manner can be easily decrypted, and an encryption format according to the present method may be converted into the encryption format of an existing file. Accordingly, there is an advantage in that compatibility with a file system, which supports a stream, is also convenient.

### BRIEF DESCRIPTION OF DRAWINGS

FIG. 1 is an exemplary view showing a conventional digital data encryption method;

FIG. 2 is a block diagram showing a configuration of a digital data processing apparatus according to a preferred embodiment of the present invention;

FIG. 3 is a flowchart showing a file encryption procedure, which is performed by a file encryption module;

FIG. 4 is an exemplary view showing an encrypted file and encryption information, which are encrypted by the file encryption module;

FIG. 5 is a flowchart showing a file decryption procedure, which is performed by a file decryption module;

FIG. 6 is an exemplary view showing a concept of encryption format conversion performed by an encryption format conversion module; and

FIG. 7 is a flowchart showing the concept of an encryption information protection function performed by a filter module.

### DESCRIPTION OF REFERENCE NUMERALS OF PRINCIPAL ELEMENTS IN THE DRAWINGS

10: application
20: file system
100: digital file processing apparatus
110: file encryption module
120: file decryption module
130: encryption format conversion module
131: first module
132: second module
140: filter module

### MODE FOR THE INVENTION

Hereinafter, the present invention will be described in detail in connection with preferred embodiments with reference to the accompanying drawings in order for those skilled in the art to be able to implement the invention. In the preferred embodiments of the present invention, specific technical terminologies are used for clarity of the content. However, it is to be understood that the present invention is not limited to specific selected terminologies and each specific terminology includes all technical synonyms operating in a similar way in order to accomplish a similar object.

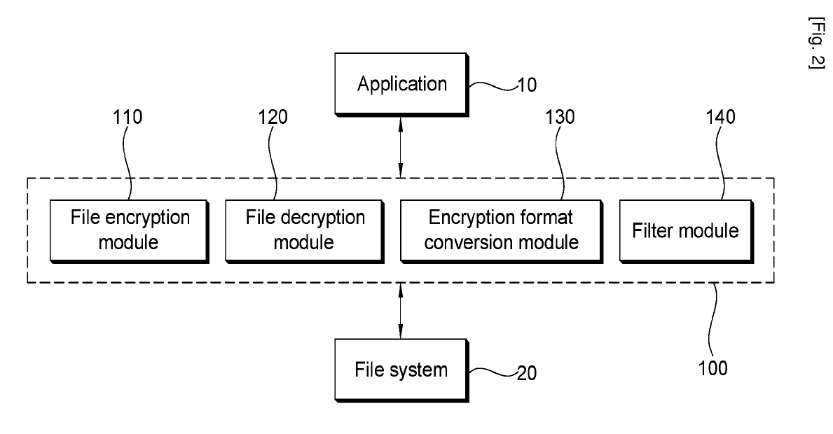

FIG. 2 is a block diagram showing a configuration of a digital data processing apparatus for implementing a digital file encryption method and a digital file decryption method according to a preferred embodiment of the present invention.

As shown in FIG. 2, a digital file processing apparatus 100 may operate in conjunction with an application 10 and a file system 20.

At this time, the application 10 may be an entity, which uses (for example, opens, edits, and stores) digital information files, for example, a program such as Word, CAD, Worksheet, Photoshop, and a moving picture or sound source player. This application 10 generates a variety of file I/Os with respect to the file system 20 of a kernel area in order to use files. For example, the application 10 may generate file I/Os for opening, reading, creation, saving, and writing, etc. of a file.

The file system 20 stores and manages files. The file system 20 may refer to a file system such as the NT file system (NTFS), which supports a stream. At this time, the terminology stream is one of functions, which are provided by a specific file system 20, so that an attribute can be further added to a digital file. For example, the NTFS, which appeared from Windows 2000, supports a stream as well as the advantages, such as the management and compression of a large-capacity file and security. In the NTFS, only space as much as a file length, which is seen by a user, is not allocated to a file, but part of a data flow called a stream can also be allocated to the corresponding file. The NTFS supports a multi-data stream.

The digital file processing apparatus 100 may perform encryption and decryption of a file, and conversion of an encryption format of the file between the application 10 and the file system 20. This digital file processing apparatus 100 may include a file encryption module 110, a file decryption module 120, an encryption format conversion module 130, and a filter module 140. Each of the modules may be placed anywhere in a user area or a kernel area in the form of software. For example, the modules may be provided in the user area or the kernel area, and some of the modules may be provided in the user area and the other of the modules may be provided in the kernel area.

When a file I/O, requiring the encryption of a file, is generated from the application 10, the file encryption module 110 encrypts the corresponding file using specific encryption information and stores it in the file system 20. The encryption information is stored in a stream in association with the stored encryption data.

Here, the encryption information may include a data encryption/decryption key, which was used when encrypting the file, policy information of the corresponding file, and the like. The policy information may include rights information such as opening, saving, edition, and printing of a file by a user; access control information about an encrypted file, such as an encryption date, an access period, a group that may access a file, DRM information, and whether a file is accessible by a user and offline; use method information, and so on.

When a file I/O, requiring decryption of an encrypted file, is generated from the application 10, the data decryption module 120 acquires encryption information, which is stored in a stream in association with the corresponding encryption file, and decrypts the encrypted file stored in the file system 20 using the encryption information.

The encryption format conversion module 130 performs a function of converting a file, which was encrypted using a first encryption format, into a second encryption format or converting a file, which was encrypted using a second encryption format, into a first encryption format. At this time, the first encryption format may refer to an encryption format in which encryption information of an encrypted file is stored in a stream, and the second encryption format may refer to an encryption format in which encryption information of an encrypted file is inserted into the encrypted file in the form of a header or a footer, that is, a conventional encryption format. This encryption format conversion module 130 may operate when transmitting and receiving a file to and from other systems that do not support a stream.

The filter module 140 may perform a function of permitting only permitted applications to access a stream having encryption information and precluding non-permitted applications from accessing a stream having encryption information. That is, the filter module 140 performs a function of protecting encryption information stored in a stream.

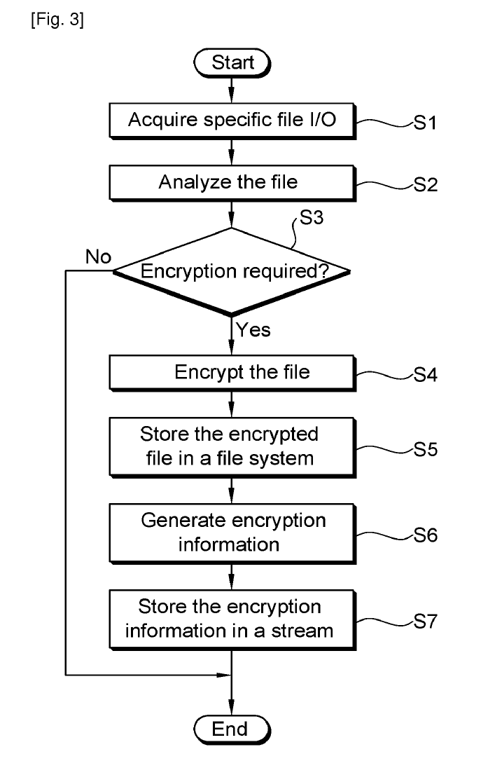

FIG. 3 is a flowchart showing a file encryption procedure, which is performed by the file encryption module 110.

As shown in FIG. 3, first, the file encryption module 110 acquires a specific file I/O, which will be processed, by hooking and filtering file I/Os generated from the application 10 at step S1. Next, the data encryption module 110 analyzes data of the acquired file I/O at step S2 and then determines whether the corresponding file is a file requiring encryption at step S3. For example, the file encryption module 110 may determine whether a corresponding file is a newly generated file or a raw-data file, which requires encryption.

At this time, if, as a result of the determination, the corresponding file is a file requiring encryption, the file encryption module 110 encrypts the corresponding file using a data encryption/decryption key at step S4 and then stores the encrypted file in the file system 20 at step S5. The data encryption/decryption key may be generated within the file encryption module or provided from the outside.

Next, the file encryption module 110 generates encryption information, including the data encryption/decryption key and policy information, at step S6 and then stores the encryption information in a stream in association with the encrypted file at step S7. At this time, the file encryption module 110 may encrypt the encryption information and store it in the stream. In this case, an encryption key of the encryption information may be generated within the file encryption module or provided from the outside.

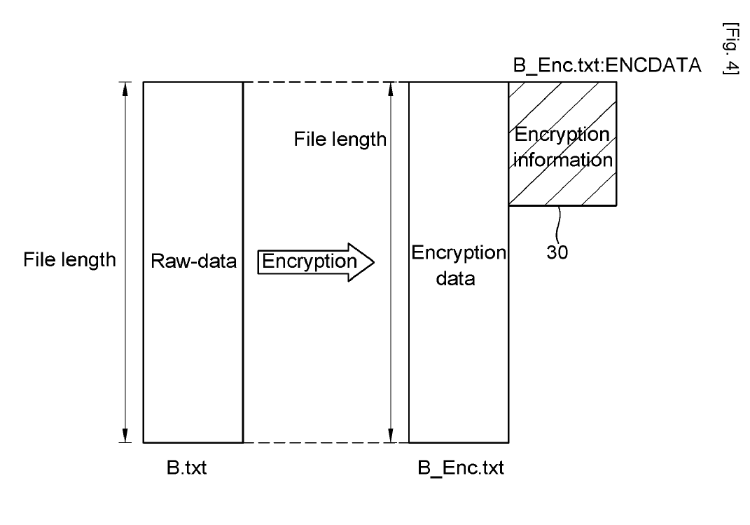

FIG. 4 is an exemplary view showing an encrypted file and encryption information, which are encrypted by the file encryption module 110.

Referring to FIG. 4, the file encryption module 110 encrypts a raw-data file using encryption information, but stores the encryption information in a stream 30 in association with the encrypted file. At this time, the terminology ‘association’ may refer to that it allows the encryption information to identify encryption information of the encrypted file. For example, the name of encryption information may be expressed by placing an identification symbol ‘:’ behind the name of a corresponding encryption file and a specific stream name behind the identification symbol. For example, in the case in which encryption information of an encrypted file B_Enc.txt, which was encrypted from B.txt, is stored in the stream 30 having a name of ‘ENCDATA,’ the encryption information may be read and written under the name of B_Enc.txt:ENCDATA.

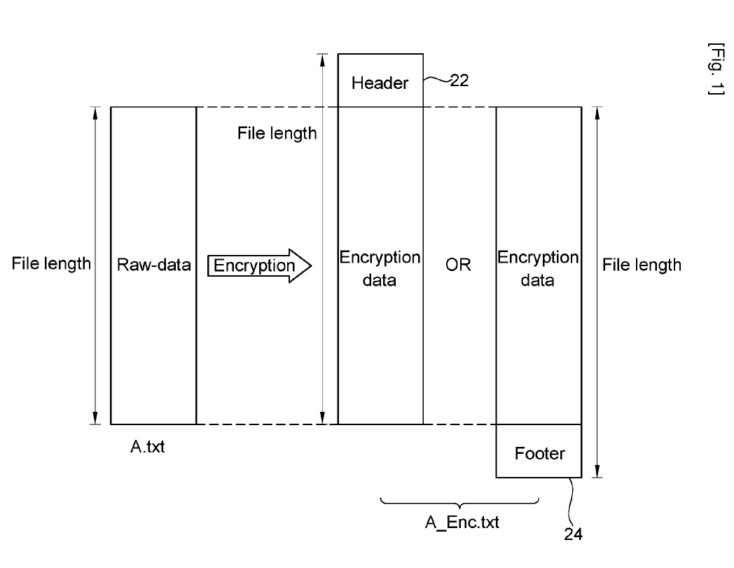

Accordingly, unlike the conventional method (refer to FIG. 1), a header or a footer, containing the encryption information, is not attached in front or rear of the file. Accordingly, the length of the original file B.txt is identical to that of the file B_Enc.txt after encryption. Consequently, the same stability as that in a file I/O with respect to raw-data may be guaranteed because an application does not need to perform correction of the length and offset of a file when using an encrypted file.

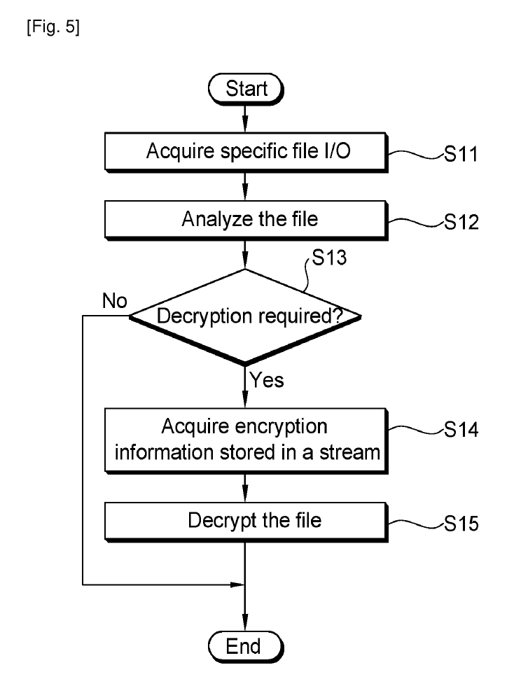

FIG. 5 is a flowchart showing a file decryption procedure, which is performed by the file decryption module 120.

As shown in FIG. 5, first, the file decryption module 120 acquires a specific file I/O, which will be processed, by hooking and filtering file I/Os generated from the application 10 at step S11. Next, the file decryption module 120 analyzes data of the acquired file I/O at step S12 and then determines whether the corresponding file is a file requiring decryption at step S13. For example, the file decryption module 120 may determine whether a corresponding file is an encrypted file.

At this time, if, as a result of the determination, the corresponding file is a file requiring decryption, the file decryption module 120 acquires encryption information of the corresponding encrypted file stored in a stream at step S14. At this time, in the case in which the encryption information is encrypted, the file decryption module 120 may decrypt the encryption information using a encryption key of the encryption information. Next, the file decryption module 120 may decrypt the encrypted file using a data encryption/decryption key included in the acquired encryption information S15.

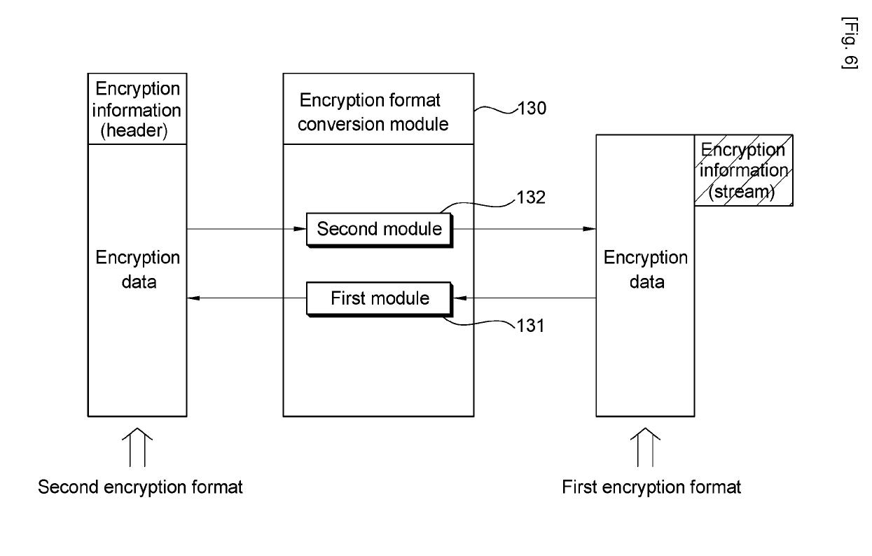

FIG. 6 is an exemplary view showing a concept of encryption format conversion performed by the encryption format conversion module 130.

As shown in FIG. 6, the encryption format conversion module 130 may include a first module 131 for converting a file, which was encrypted using a first encryption format, into a second encryption format and a second module 132 for converting a file, which was encrypted using a second encryption format, into a first encryption format. As described above, the first encryption format may refer to an encryption format in which encryption information of an encrypted file is stored in a stream, and the second encryption format may refer to an encryption format in which encryption information of an encrypted file is inserted into the encrypted file in the form of a header (or footer).

This encryption format conversion module 130 may operate when transmitting or receiving files to or from other systems (for example, FAT16, FAT32, and CDFS), which do not support a stream, or for the purpose of applications (for example, ALZip), which do not support a stream.

For example, in the case in which an encrypted file, stored using the first encryption format, is transmitted to other systems (i.e., a file system supporting only the second encryption format) which do not support a stream, there is a need for a conversion process of converting the first encryption format into the second encryption format. In this case, the first module 131 of the encryption format conversion module 130 may acquire encryption information, which is stored in a stream, in response to a request from, for example, a specific application or a user and attach the encryption information to a front or rear part of the encrypted file as a header or a footer.

However, in the case in which an encrypted file is received from other systems that support only the second encryption format, there may be a need for a process of converting the second encryption format into the first encryption format. In this case, the second module 132 of the encryption format conversion module 130 may cut a header (or footer) portion of the encrypted file, which is stored using the second encryption format, and store the cut header (or footer) portion in a stream in association with the encrypted file when storing the encrypted file.

Meanwhile, when a user or a specific application requests format conversion, the encryption format conversion module 130 may be configured in the form of a manual operation module, which performs the format conversion in response to the request, or in the form of an automatic operation module, which automatically performs the format conversion when the application 10 uses the encrypted file.

An example in which the encryption format conversion module 130 is configured using the automatic operation module is described below. The encryption format conversion module 130 may be configured in the form of a file system filter at the kernel stage, which converts an encryption format into real-time stream encryption form when an application uses an encrypted file. For example, in the case in which a user executes an encrypted file of the second encryption format, which is stored in the NTFS, using an application, the file system filter may automatically convert the second encryption format into the first encryption format and then decrypt the encrypted file.

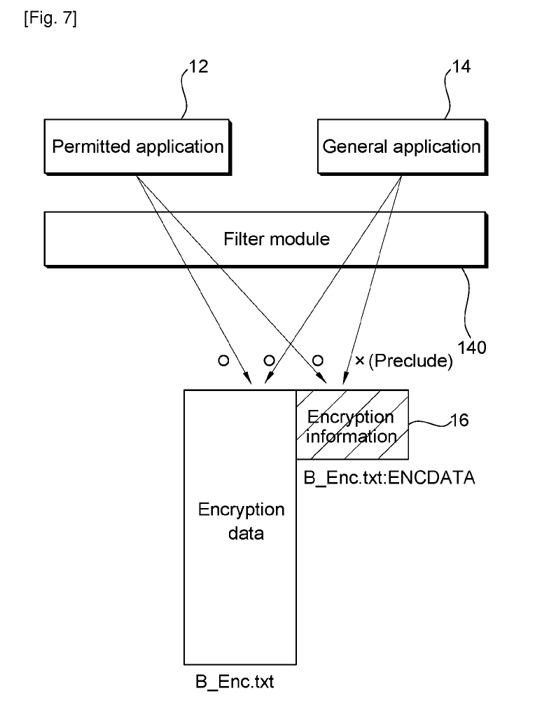

FIG. 7 is a flowchart showing the concept of an encryption information protection function performed by the filter module 140.

As shown in FIG. 7, the filter module 140 assigns, to only a permitted application 12, rights from which encryption information stored in the stream 16 can be accessed, but precludes access from a general application 14 to the stream 16. For example, in the case in which there is a request from a specific application to access encryption information stored in a steam, the filter module 140 may determine whether the corresponding application is a permitted application and, if, as a result of the determination, the corresponding application is not a permitted application, preclude the corresponding application from accessing the encryption information. This filter module may be implemented in the form of a file system filter or a mini filter, for example, in a kernel area.

As described above, the present invention has been described in connection with the preferred embodiments. According to the present invention, encryption information of a file is not inserted into a front or rear part of the corresponding file when the file is encrypted, but stores the encryption information in a stream supported by a file system. Since a file length before encryption is identical to a file length after the encryption, it is not necessary for an application to perform correction of the length and offset, of a file, when using an encrypted file. This leads to the stability of a file I/O and an improved processing speed.

Meanwhile, those skilled in the art will understand that the present invention may be modified and changed in various ways without departing from the spirit and scope of the appended claims. Accordingly, future changes of the embodiments of the present invention may not deviate from the technology of the present invention.

1. A digital file encryption method, comprising the steps of:
encrypting a file using specific encryption information and storing the encrypted file in a file system; and
storing the encryption information in a stream provided by the file system.

2. The digital file encryption method of claim 1, wherein the encryption information comprises a data encryption/decryption key, which was used to encrypt the file, and policy information about the file.

3. The digital file encryption method of claim 2, wherein the step of storing the file in the file system comprises the steps of:
converting the file to the encrypted file by encrypting the file using the data encryption/decryption key; and
storing the encrypted file in the file system.

4. The digital file encryption method of claim 3, wherein the step of storing the encryption information in the stream comprises the steps of:
encrypting the encryption information using a specific encryption key; and
storing the encrypted encryption information in the stream in association with the encrypted file.

5. The digital file encryption method of claim 3, wherein a name of the encryption information comprises a name of the encrypted file, a specific identification symbol, and a unique name.

6. The digital file encryption method of claim 1, further comprising the steps of:
acquiring a specific file input/output (I/O) to be processed by hooking and filtering file I/Os generated from an application; and
analyzing the acquired file I/O in order to determine whether a corresponding file requires encryption.

7. A digital file decryption method, comprising the steps of:
in order to decrypt an encrypted file stored in a file system, acquiring encryption information stored in a stream provided by the file system; and
decrypting the encrypted file using data encryption/decryption key included in the encryption information.

8. The digital file decryption method of claim 7, wherein the step of acquiring the encryption information comprises the steps of:
acquiring encrypted encryption information stored in the stream;
decrypting the encrypted encryption information using a specific encryption key; and
acquiring the data encryption/decryption key from the decrypted encryption information.

9. The digital file decryption method of claim 7, further comprising the steps of:
acquiring a specific file I/O to be processed by hooking and filtering file I/Os generated from an application; and
analyzing the acquired file I/O in order to determine whether a corresponding file requires decryption.

10. A digital file processing apparatus, comprising:
a file encryption module for encrypting a file, requiring encryption, using specific encryption information, storing the encrypted file in a file system, and storing the encryption information in a stream in association with the stored encrypted file; and
a file decryption module for acquiring the encryption information of the encrypted file from the stream and decrypting the encrypted file using the acquired encryption information.

11. The digital file processing apparatus of claim 10, wherein the file encryption module converts the specific file into the encrypted file using a data encryption key, which is generated on its own or provided externally, and stores the encryption information, including the data encryption key, in the stream.

12. The digital file processing apparatus of claim 10, wherein at least one of the file encryption module and the file decryption module hooks and filters file I/Os generated from an application.

13. The digital file processing apparatus of claim 10, further comprising an encryption format conversion module for converting a first encryption format into a second encryption format,
wherein the first encryption format is an encryption format of a type in which encryption information of an encrypted file is stored in a stream, and the second encryption format is an encryption format of a type in which encryption information of an encrypted file is inserted into the encrypted file as a header or a footer of the encrypted file.

14. The digital file processing apparatus of claim 13, wherein the encryption format conversion module further includes a function of converting the second encryption format into the first encryption format.

15. The digital file processing apparatus of claim 14, wherein the encryption format conversion module performs encryption format conversion in real time when an encryption file is used.

16. The digital file processing apparatus of claim 10, further comprising a filter module for allowing only permitted applications to access the stream having the encryption information, and precluding non-permitted applications from accessing the stream having the encryption information.

17. An encryption format conversion apparatus, comprising:
a first module for converting a file, encrypted using a first encryption format, into a file having a second encryption format; and
a second module for converting a file, encrypted using the second encryption format, into a file having the first encryption format,
wherein the first encryption format is an encryption format of a type in which encryption information of an encrypted file is stored in a stream, and the second encryption format is an encryption format of a type in which encryption information of an encrypted file is inserted into the encrypted file as a header or a footer of the encrypted file.
